(19) United States
(12) Patent Application Publication
(10) Pub. No.: US 2002/0115584 A1
(43) Pub. Date: Aug. 22, 2002

(54) Polymer containing granules and compositions thereof

(75) Inventors: Steven Rene Martha Ongena, St. Gillis Waas (BE); Iwein Jozef Marie Jaak Goderis, Boortmeerbeek (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/007,039

(22) Filed: Nov. 5, 2001

(30) Foreign Application Priority Data
Nov. 6, 2000 (EP) 00124074.6

(51) Int. Cl. C11D 17/00

(52) U.S. Cl. 510/446; 510/452

(57) ABSTRACT

According to the present invention there is provided polymer-containing granules for addition to detergent compositions, said granule comprising:

(a) 0.1-99.9%, by weight, of polycarboxylate; and

(b) 0.1-99.9%, by weight, of material having a solubility of at least about 270 g/l.

A further aspect of the present invention provides detergent compositions comprising the above mentioned polymer-containing granules. A further aspect of the present invention provides a process for producing said granules. A further aspect of the present invention relates to the use of a material having a solubility of at least about 270 g/l to retard the gelling behavior of polymers.

### CROSS REFERENCE TO RELATED APPLICATIONS

This application claims priority under 35 U.S.C. §119(a) to European Application Serial No., 00124074.6 filed Nov. 6, 2000 (Attorney Docket No. CM2465F).

### TECHNICAL FIELD

The present invention relates to a polymer containing granules and detergent compositions comprising said granules. In addition, the present invention relates to processes for producing polymer containing granules.

### BACKGROUND OF THE INVENTION

Certain polycarboxylates are known to be useful in detergent compositions. See, for example, U.S. Pat. No. 3,308,067. These polymers serve a number of functions including acting as builders. The polymers are generally added to detergent compositions as dry powders formed by a spray drying or co-granulation process. However, there are a number of problems associated with the use of polymers. One of the main problems is that dry powder polymers tend to ‘gel’ when they come into contact with water. Even though the polymers themselves are water-soluble, when they come into contact with water the outer layer of polymer gels trapping a core of undissolved material. This is undesirable in detergent compositions as it slows the dissolution of the detergent in the wash liquor, hence, delaying the detergency action. This gelling behavior is particularly undesirable when the polymer is added into detergent tablet compositions which must quickly dissolve to be able to enter the wash. For a discussion of the problems associated with using polymers in detergent compositions see EP-A-421,664.

It has now been found that the gelling behavior of polycarboxylates in detergent compositions can be retarded if the polymer is added to the composition as a granule comprising polymer and a material having a certain solubility. The gelling behavior can be further retarded if the polymer is produced by spray-drying rather than co-granulation.

While not wishing to be bound by theory, it is believed that the soluble material in the polymer-containing granule helps to retard the formation of tertiary structure that is essential for gelling to occur. Furthermore, when a polycarboxylate granule contains a large proportion of ‘fines’ are more likely to form gels. Spray-drying the polymer-containing granules lowers the proportion of fines and produces more chemically uniform particles and this further helps to retard gelling.

### SUMMARY OF THE INVENTION

According to the present invention there is provided polymer-containing granules for addition to detergent compositions, said granule comprising:

(a) 0.1-99.9%, by weight, of polycarboxylate; and

(b) 0.1-99.9%, by weight, of material having a solubility of at least about 270 g/l.

A further aspect of the present invention provides detergent compositions comprising the above mentioned polymer-containing granules. A further aspect of the present invention provides a process for producing said granules. A further aspect of the present invention relates to the use of a material having a solubility of at least about 270 g/l to retard the gelling behavior of polymers.

As used herein the term “granule” means a particle of any suitable size or shape that can be added to detergent compositions.

As used herein the term “solubility” refers to the solubility of the anhydrous salt of a material in deionized water at 20° C.

Unless otherwise indicated, all ingredients expressed herein are on a weight percentage of the active ingredient.

### DETAILED DESCRIPTION OF THE INVENTION

According to the present invention there is provided polymer-containing granules comprising polycarboxylate and of material having a solubility of at least about 270 g/l. These elements will be described in more detail below. Further aspects of the present invention relate to detergent compositions comprising the granules and processes for producing them.

The polymer-containing granules of the present invention do not demonstrate a high propensity to gel when in contact with water. In addition, detergent compositions comprising the granules of the present invention are quick to dissolve and do not leave residues on the wash load.

### Polycarboxylates

The polymer-containing granules of the present invention must contain from 0.1% to 99.9%, by weight, of polycarboxylate. As used herein the term “polycarboxylate” includes homopolymers and heteropolymers (co-polymers) of carboxylates. Any polycarboxylate or mixture of polycarboxylate suitable for inclusion in detergent compositions may be used herein. A description of certain suitable polycarboxylates can be found in U.S. Pat. No. 3,308,067. Preferred polycarboxylates for use herein include water-soluble salts of homo- and copolymer of aliphatic carboxylic acids such as acrylic acid, maleic acid, itaconic acid, mesaconic acid, fumaric acid, aconitic acid, citaconic acid, and mixtures thereof. Preferably the polymers of the present invention are co-polymers of acrylic and maleic acid. The preferred co-polymers of acrylic and maleic acid have a ratio of acrylic to maleic monomers of from 80:20 to 20:80, more preferably from 70:30 to 50:50.

Preferably, the polycarboxylates for use herein have a molecular weight of from 5000 to 100,000, more preferably from 20,000 to 100,000.

Preferred commercially available acrylic acid containing polymers include those sold under the tradename Sokalan PA13 PN, PA30, PA20, PA15, PA10 and Sokalan CP5 by BASF GmbH, and those sold under the tradename Acusol 45N, 425N, 445, 445N, 460N, 464N, 480N, 497N, by Rohm and Haas.

Preferably the granules of the present invention comprise from 10% to 95%, by weight, of polycarboxylate. More preferably the present granules comprise from 40% to 90%, even more preferably from 50% to 85% by weight, of polycarboxylate.

### Soluble Materials

The polymer-containing granules of the present invention also comprise from 0.1% to 99.9%, by weight, of material having a solubility of at least about 270 g/l. Preferably, the granules of the present invention comprise from 5% to 90%, more preferably from 10% to 60%, even more preferably from 15% to 50%, by weight, of material having a solubility of material having a solubility of at least about 270 g/l.

The solubility of materials can be easily found from a number of sources. For example, “Handbook of Chemistry & Physics”, CRC Press LLC, 80th edition, (1999/2000).

Any material suitable for inclusion in a polymer-containing granule and having a solubility of at least 270 g/l may be used herein. Preferably, the materials for use herein have a solubility of at least 300 g/l, more preferably at least 350 g/l, even more preferably at least 400 g/l, even more preferably of at least 600 g/l,

While not wishing to be bound by theory it is believed that materials having a solubility in this range alter the solubility profile of the polymers to the correct degree to retard the polymers propensity to gel while not significantly slowing the dissolution of the polymer.

Since the polymer-granules are added to the detergent compositions as dry particles the soluble substance must be capable of being incorporated into such a dry particle.

The soluble material of the present invention is eventually incorporated into detergent compositions. Therefore, it is highly preferable that the material or materials be environmentally-friendly, relatively common, easy to acquire/produce and reasonably cheap.

Another property of the soluble material that has been found to be important is the degree of hydration that the soluble materials can achieve. As used herein the term “degree of hydration” means the moles of water required to form a stable hydrate with one mole of material. Materials having no degrees of hydration have been found to be poor at retarding the gelling while materials with a degree of hydration greater than 6 have been found to retard dissolution of the polymer. Again, while not wishing to be bound by theory, it is believed that materials having more than 6 degrees of hydration prevent the polymer from being quickly exposed to water and hence slow its dissolution. Therefore, the soluble materials for use herein preferably have a degree of hydration of from 1 to 6, more preferably from 2 to 4.

Preferred materials for use herein are organic or partially organic salts. Preferred are citrate and salts thereof, acetate and salts thereof, and mixtures thereof. Especially preferred is citrate and salts thereof.

Therefore, the granules of the present invention preferably comprise co-polymer of acrylic and maleic acid and citrate and salts thereof.

### Process

The polymer-containing granules of the present invention are preferably prepared using a spray-drying process. Such processes are well-known in the art (see, for example, “Spray Drying Handbook” by K. Masters, Longman Scientific & Technical, 5th edition (1991).

### Detergent Compositions

The granules described herein above can be used in any detergent composition. Preferably, the detergent compositions of the present invention comprise from 0.1% to 50%, more preferably from 0.5% to 25%, even more preferably from 1% to 15%, by weight, of the polymer-containing granules as described hereinabove.

Detergent compositions and methods of producing them are well-known in the art. Detergent compositions usually comprise a surfactant and can comprise a number of optional ingredients such as enzymes, bleaches, fabric softeners, builders, perfumes, chelating agents, etc. Some of the preferred optional ingredients are described below.

### Surfactant

Any suitable surfactant may be used. Preferred surfactants are selected from anionic, amphoteric, zwitterionic, nonionic (including semi-polar nonionic surfactants), cationic surfactants and mixtures thereof.

The compositions preferably have a total surfactant level of from 0.5% to 75% by weight, more preferably from 1% to 50% by weight, most preferably from 5% to 30% by weight of total composition.

Preferably the particles comprising surfactant in the present compositions are at least about 90% dissolved in the wash liquor, at the latest, within ten minutes of the start of the main wash cycle of the washing machine. This allows the agents for use in the main wash cycle to enter the wash liquor quickly. It is preferred that the surfactant reaches its peak concentration in the wash liquor within the first ten minutes, preferably within the first five minutes, more preferably within the first two minutes of the main wash cycle of a washing machine.

Detergent surfactants are well-known and fully described in the art (see, for example, “Surface Active Agents and Detergents”, Vol. I & II by Schwartz, Perry and Beach). Some examples of suitable surfactants for use herein can be found in EP-A-971023.

### Cationic Softening Agents

Any suitable cationic fabric softener may be used herein. Preferably the present compositions comprise from 0.01% to 40%, more preferably from 0.1% to 15%, even more preferably 0.5% to 5%, by weight of total composition, of cationic fabric softener. Preferably, the cationic fabric softener for use herein is selected from quaternary ammonium agents. As used herein the term “quaternary ammonium agent” means a compound or mixture of compounds having a quaternary nitrogen atom and having one or more, preferably two, moieties containing six or more carbon atoms. Preferably the quaternary ammonium agents for use herein are selected from those having a quaternary nitrogen substituted with two moieties wherein each moiety comprises ten or more, preferably 12 or more, carbon atoms.

### Builders

The compositions of the present invention can comprise builders. Builders for use in laundry compositions are well-known in the art. See, for example, “Detergent Manufacture Including Zeolite Builders & Other New Materials”, M. Sittig, Chemical Technology Review No. 128 (1979).

Suitable partially water-soluble builder compounds for use herein include crystalline layered silicates as disclosed in EP-A-164,514 and EP-A-293,640. Preferred crystalline layered sodium silicates of general formula:

NaMSiₓO₂₊₁.yH₂O

wherein M is sodium or hydrogen, x is a number from 1.9 to 4 and y is a number from 0 to 20. Crystalline layered sodium silicates of this type preferably have a two dimensional sheet structure, such as the so called δ-layered structure as described in EP-A-164,514 and EP-A-293,640. Methods of preparation of crystalline layered silicates of this type are disclosed in DE-A-3,417,649 and DE-A-3,742,043. A more preferred crystalline layered sodium silicate compound has the formula δ-Na₂Si₂O₅, known as NaSKS-6™ available from Hoeschst AG.

Suitable largely water-insoluble builder compounds for use herein include the sodium aluminosilicates. Suitable aluminosilicates include the aluminosilicate zeolites having the unit cell formula Na_{z}[(AlO₂)₂(SiO₂)_{y}].xH2O wherein z and y are at least 6, the molar ratio of z to y is from 1 to 0.5 and x is at least 5, preferably from 7.5 to 276, more preferably from 10 to 264. The aluminosilicate material are in hydrated form and are preferably crystalline, containing from 10% to 28%, more preferably from 10% to 22% water in bound form. The aluminosilicate zeolites can be naturally occurring materials but are preferably synthetically derived. Synthetic crystalline aluminosilicate ion exchange materials are available under the designations Zeolite A, Zeolite B, Zeolite P, Zeolite X, and Zeolite HS. Preferred aluminosilicate zeolites are colloidal aluminosilicate zeolites. When employed as a component of a detergent composition colloidal aluminosilicate zeolites, especially colloidal zeolite A, provide enhanced builder performance, especially in terms of improved stain removal, reduced fabric encrustation and improved fabric whiteness maintenance. Mixtures of colloidal zeolite A and colloidal zeolite Y are also suitable herein providing excellent calcium ion and magnesium ion sequestration performance.

### Tablets

As mentioned above, the granules of the present invention are especially useful in detergent tablet compositions. A description of suitable detergent tablet compositions can be found in EP-A-1026228.

### Disintegration Aid

It is highly preferred that such tablet compositions comprise a disintegration aid. As used herein, the term “disintegration aid” means a substance or mixture of substances that has the effect of hastening the dispersion of the matrix of the present compositions on contact with water. This can take the form of a substance which hastens the disintegration itself or substances which allow the tablet to be formulated or processed in such a way that the disintegrative effect of the water itself is hastened. For example, suitable disintegration aid include clays that swell on contact with water (hence breaking up the matrix of the compositions) and coatings which increase tablet integrity allowing lower compression forces to be used during manufacture (hence the tablets are less dense and more easily dispersed.

Any suitable disintegration aid can be used but preferably they are selected from disintegrants, coatings, effervescents, binders, clays, highly soluble compounds, cohesive compounds, and mixtures thereof. These are described in more detail below.

Possible disintegrants for use herein include those described in the Handbook of Pharmaceutical Excipients (1986). Examples of suitable disintegrants include clays such as bentonite clay; starch: natural, modified or pregelatinised starch, sodium starch gluconate; gum: agar gum, guar gum, locust bean gum, karaya gum, pectin gum, tragacanth gum; croscarmylose sodium, crospovidone, cellulose, carboxymethyl cellulose, algenic acid and its salts including sodium alginate, silicone dioxide, polyvinylpyrrolidone, soy polysaccharides, ion exchange resins, and mixtures thereof.

The tablet compositions of the present invention can be coated. The preferred coatings and methods for use herein are described in EP-A-846,754, herein incorporated by reference. As specified in EP-A-846,754, preferred coating ingredients are for example dicarboxylic acids. Particularly suitable dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid. In a preferred embodiment, the coating comprises an acid having a melting temperature of at least 145° C., such as adipic acid for example, as well as a clay, such as a bentonite clay for example, whereby the clay is used as a disintegrant and also to render the structure of adipic acid more favourable for water penetration, thus improving the dispersion of the adipic acid in a aqueous medium. Another preferred materials for use in the coating herein is cation exchange resins, typically as described in Kirk-Othmer's Encyclopedia of Chemical Technology, 4^{th} Edition, Volume 14, pp 738-740. The preferred cation-exchange resins for use herein are those sold by Purolite under the names Purolite® C100NaMR, a sodium salt sulfonated poly(styene-divinylbenzene) co-polymer and Purolite® C100CaMR, a calcium salt sulfonated poly(styene-divinylbenzene) co-polymer.

The tablet compositions of the present invention can comprise an effervescent. As used herein, effervescency means the evolution of bubbles of gas from a liquid, as the result of a chemical reaction between a soluble acid source and an alkali metal carbonate, to produce carbon dioxide gas. An effervescent may be added to the tablet mix in addition to the detergent ingredients. Effervescents are known in the art and include such materials as sodium acetate, nitrilotriacetic acid and salts thereof or urea. A list of suitable dispersion aid may also be found in Pharmaceutical Dosage Forms: Tablets, Vol. 1,2nd Edition, Edited by H. A. Lieberman et al, ISBN 0-8247-8044-2.

Non-gelling binders can be integrated to the particles forming the tablet in order to facilitate dispersion. If non-gelling binders are used they are preferably selected from synthetic organic polymers such as polyethylene glycols, polyvinylpyrrolidones, polyacetates, water-soluble acrylate copolymers, and mixtures thereof. The handbook of Pharmaceutical Excipients 2nd Edition has examples of other suitable binder materials. Examples include ethoxylated hexamethylene diamine quaternary compounds, bishexamethylene triamines or other such as pentaamines, ethoxylated polyethylene amines, maleic acrylic polymers.

The compositions herein may also comprise expandable clays. These are generally three-layer clays such as aluminosilicates and magnesium silicates having an ion exchange capacity of at least 50 meq/100 g of clay. The three-layer expandable clays used herein are classified geologically as smectites. Examples of clays useful herein include montmorillonite, volchonskoite, nontronite, hectorite, saponite, sauconitem, vermiculite and mixtures thereof. It is to be recognised that such smectite-type minerals obtained under the foregoing tradenames can comprise mixtures of the various discrete mineral entities. Such mixtures of the smectite minerals are suitable for use herein.

The compositions of the present invention may comprise highly soluble compounds. Such a compound could be formed from a mixture or from a single compound. Suitable highly soluble compounds are described in more detail in EP-A-1026228. Examples of preferred highly soluble compounds include salts of acetate, urea, citrate, phosphate, sodium diisobutylbenzene sulphonate (DIBS), sodium toluene sulphonate, and mixtures thereof.

The compositions herein may comprise a compound having a Cohesive Effect on the particulate material of a detergent matrix forming the composition. The Cohesive Effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength are given in Pharmaceutical Dosage Forms:

Tablets volume 1 Ed. H. A. Lieberman et al, published in 1989. A more detailed description of suitable compounds having a cohesive effect can be found in EP-A-1026228. An example of a compound having a cohesive effect is sodium diisoalkylbenzene sulphonate.

### Chelants/Heavy Metal Ion Sequestrant

The compositions of the present invention preferably contain as an optional component a chelants or heavy metal ion sequestrant. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper.

Heavy metal ion sequestrants are generally present at a level of from 0.005% to 20%, preferably from 0.1% to 10%, more preferably from 0.25% to 7.5% and most preferably from 0.5% to 5% by weight of the compositions.

Heavy metal ion sequestrants, which are acidic in nature, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. Preferably any salts/complexes are water soluble. The molar ratio of said counter cation to the heavy metal ion sequestrant is preferably at least 1:1.

Suitable heavy metal ion sequestrants for use herein include organic phosphonates, such as the amino alkylene poly (alkylene phosphonates), alkali metal ethane 1-hydroxy disphosphonates and nitrilo trimethylene phosphonates. Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate. Other suitable heavy metal ion sequestrant for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof. Especially preferred is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt or complex thereof.

### Perfume

The compositions of the present invention can comprise a perfume component. This perfume component can comprise an encapsulate perfume, a properfume, neat perfume materials, and mixtures thereof. A wide variety of chemicals are known for perfumery uses, including materials such as aldehydes, ketones, esters and the like. More commonly, naturally occurring plant and animal oils and exudates comprising complex mixtures of various chemicals components are known for use as perfumes, and such materials can be used herein. The perfumes herein can be relatively simple in their composition or can comprise highly sophisticated, complex mixtures of natural and synthetic chemical components, all chosen to provide any desired odor. The invention also encompasses the use of materials which act as malodor counteractants. These materials, although termed “perfumes” hereinafter, may not themselves have a discernible odor but can conceal or reduce any unpleasant doors. Examples of suitable malodor counteractants are disclosed in U.S. Pat. No. 3,102,101, issued Aug. 27, 1963, to Hawley et al.

By encapsulated perfumes it is meant perfumes that are encapsulated within a capsule comprising an encapsulating material or a perfume which is loaded onto a, preferably porous, carrier material which is then preferably encapsulated within a capsule comprising an encapsulating material. A wide variety of capsules exist which will allow for delivery of perfume effect at various times during the use of the detergent compositions. Examples of such capsules with different encapsulated materials are capsules provided by microencapsulation. Here the perfume comprises a capsule core which is coated completely with a material which may be polymeric. U.S. Pat. No. 4,145,184, Brain et al, issued Mar. 20, 1979, and U.S. Pat. No. 4,234,627, Schilling, issued Nov. 18, 1980, teach using a tough coating material which essentially prohibits the diffusions out of the perfume. The encapsulating materials of the perfumed particles is preferably a water-soluble or water-dispersible encapsulating material. Nonlimiting examples of suitable water-soluble coating materials include such substances as methyl cellulose, maltodextrin and gelatin. Especially suitable water-soluble encapsulating materials are as described in GB-A-1,464,616 and in U.S. Pat. No. 3,455,838.

The perfume component may alternatively comprise a pro-perfumes. Pro-perfumes are perfume precursors which release the perfume on interaction with an outside stimulus for example, moisture, pH, chemical reaction. Pro-perfumes suitable for use herein include those known in the art. Suitable pro-perfumes can be found in the art including U.S. Pat. Nos.: 4,145,184, Brain and Cummins, issued Mar. 20, 1979; U.S. Pat. No. 4,209,417, Whyte, issued Jun. 24, 1980; U.S. Pat. No. 4,545,705, Moeddel, issued May 7, 1985; and U.S. Pat. No. 4,152,272, Young, issued May 1, 1979; U.S. Pat. No. 5,139,687 Borcher et al. Issued Aug. 18, 1992 and U.S. Pat. No 5,234,610 Gardlik et al. Issued Aug. 10, 1993.

### Enzymes

The compositions of the present invention can comprise enzymes. Where present said enzymes are preferably selected from cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase or mixtures thereof. See WO-A-00/04129 for a more detailed discussion of enzymes.

### Bleaching System

The compositions of the present invention may comprise a bleaching system. Bleaching systems typically comprise a “bleaching agent” (source of hydrogen peroxide) and an “initiator” or “catalyst”. When present, bleaching agents will typically be at levels of from about 1%, preferably from about 5% to about 30%, preferably to about 20% by weight of the composition. If present, the amount of bleach activator will typically be from about 0.1%, preferably from about 0.5% to about 60%, preferably to about 40% by weight, of the bleaching composition comprising the bleaching agent-plus-bleach activator. A description of some suitable bleaches can be found in WO-A-00/04129.

### Other Ingredients

The compositions herein can comprise any other material or mixture of materials suitable for a detergent composition. For example, wrinkle reducing agents (such as those found in WO-A-99/55953), fabric abrasion reducing polymers (such as those that are described in WO-A-00/15745), chlorine scavengers (such as ammonium chloride), dye fixing agents, suds suppressing systems and antifoam compounds such as those disclosed in WO-A-93/08876 and EP-A-705 324), polymeric dye transfer inhibiting agents, soil release agents (such as those described in U.S. Pat. No. 4,968,45 1, U.S. Pat. No. 4,711,730, U.S. Pat. No. 4,721,580, U.S. Pat. No. 4,702,857, U.S. Pat. No. 4,877,896), optical brighteners, clay softening system (such as those described in U.S. Pat. No. 3,862,058, U.S. Pat. No. 3,948,790, U.S. Pat. No. 3,954,632, U.S. Pat. No. 4,062,647, EP-A-299,575 and EP-A-313,146), alkali metal silicate, colourant, lime soap dispersant (such as those described in WO-A-93/08877), and compatible mixtures thereof.

### EXAMPLES

The following examples further illustrate the preferred embodiments within the scope of the present invention. The examples are given solely for the purposes of illustration and are not to be construed as limitations of the present invention as many variations of the invention are possible without departing from its spirit or scope.

Example 1 - Polymer Granules

| | Example 1 | Comparative 1 |
|---|---|---|
| | (weight %) | (weight %) |
| 50:50 Acrylic: Maleic co- | 80 | 50 |
| polymer¹ | | |
| Sodium Citrate | 20 | — |
| Sodium Carbonate | — | 50 |

¹Available from Rohm & Haas

The polymer granules were prepared by mixing together the ingredients in solution and then spray-drying. These particles were then tested by placing 100 g in the dispensing drawer of a Bauknecht WA9850. Water at 8° C. is then passed over the polymer granules at a rate of 4 liters per minute for a total time of 30 or 45 seconds. The residue was collected and the ‘% residue calculated’.

| Dispensing Residue | | |
|---|---|---|
| (weight %) | Example 1 | Comparative 1 |
| Time 45 seconds | 0 | 1.2 |
| Time 30 seconds | 2.3 | 16.3 |

### EXAMPLE 2

TABLE 2
Detergent base Powder composition

| | Composition A | Composition B |
|---|---|---|
| | (%) | (%) |
| Anionic agglomerates¹ | 56.66 | 56.66 |
| Sodium Carbonate | 17.06 | 10.74 |
| Bleach activator | 3.31 | 3.31 |
| agglomerates² | | |
| Sodium percarbonate | 3.41 | 3.41 |
| Citric Acid Anhydrous | 5.00 | 5.00 |
| Suds Suppressor³ | 0.30 | 0.30 |
| Sodium Acetate Anhydrous | 2.00 | 2.00 |
| Polymer Particle | 9.29 | 15.6 |
| | (Particle of Ex. 1) | (Particle of Comp. Ex. 2) |
| Fluorescer | 0.15 | 0.15 |
| Polyethylene Glycol | 1.39 | 1.39 |
| Hexanediol | 0.11 | 0.11 |
| Perfume | 0.25 | 0.25 |

¹Anionic agglomerates 1 comprise 40% anionic surfactant, 27% zeolite and 33% carbonate
²Bleach activator agglomerates comprise 81% Teraacetylethylene diamine (TAED), 17% acrylic/maleic copolymer (acid form) and 2% water
³Suds suppresser comprises 11.5% silicone oil (ex Dow Corning), 59% zeolite and 29.5% H₂O

A detergent base powder of the above compositions was prepared as follows:

i) all the particulate materials were mixed together in a mixing drum to form a homogeneous particulate mixture. During this mixing the liquid spray-on was carried out.

ii) The detergent powder is than compacted into tablets with a weight of 15 g and size of 19 by 19 mm. The tablets are compressed at different forces resulting in different tablet densities.

iii) After compaction the tablets are then coated with a coating of dicarboxylic acid mixed with an exchange resin.

In order to test the efficacy of the invention four tablets for each composition were made at different densities. The dispensing was then tested using the ‘Tablet Dispensing Protocol’.

### Tablet Dispensing protocol

1. Record the weight of 2 Tablets

2. Put 2 tablets in the dispensing drawer at the back of the drawer

3. Dispensing rig is foreseen with a top shower water intake.

4. Water at 8° C., is passed over the product at a rate of 5L/min for a total time of 300 seconds.

5. Weigh the residue left in the drawer.

6. % residues is calculated according to the formula in Example 1

Dispensing data at different density:

### Composition A

| | | | | |
|---|---|---|---|---|
| Tablet Density (g/l) | 979 | 1005 | 1033 | 1068 |
| % Residues | 0 | 0 | 10.5 | 18.8 |

### Composition B

| | | | | |
|---|---|---|---|---|
| Tablet Density (g/l) | 989 | 1021 | 1037 | 1069 |
| % Residues | 0 | 22.6 | 28.7 | 55.1 |

What is claimed is:

1. A granule for addition to detergent compositions, the granule comprising:
(a) 0.1-99.9%, by weight, of polycarboxylate; and
(b) 0.1-99.9%, by weight, of material having a solubility of at least 270 g/l.

2. A granule according to claim 1 wherein the granule comprises 10% to 95%, by weight, of polycarboxylate and 5% to 90%, by weight, of material having a solubility at least 270 g/l.

3. A granule according to claim 1 wherein the polycarboxylate is selected from water-soluble salts of homo- and copolymer of acrylic acid, maleic acid, itaconic acid, mesaconic acid, fumaric acid, aconitic acid, citaconic acid, and mixtures thereof.

4. A granule according to claim 1 wherein the polycarboxylate is a co-polymer of acrylic and maleic acid.

5. A granule according to claim 1 wherein the material has a solubility of at least 300 g/l.

6. A granule according to claim 1 wherein the material is selected materials having a degree of hydration of from 1 to 6.

7. A granule according to claim 1 wherein the material is selected from citrate and salts thereof, acetate and salts thereof, and mixtures thereof.

8. A granule according to claim 1 wherein the granule is produced by spray-drying.

9. A detergent composition comprising a granule according to claim 1.
